(19) United States
(12) Patent Application Publication
(10) Pub. No.: US 2010/0312805 A1
(43) Pub. Date: Dec. 9, 2010

(54) SYSTEM AND METHOD FOR CAPTURING, MANAGING, AND DISTRIBUTING COMPUTER FILES

(76) Inventor: Donal Charles NOONAN, III, Charleston, SC (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/776,810

(22) Filed: May 10, 2010

Related U.S. Application Data
(60) Provisional application No. 61/176,763, filed on May 8, 2009.

(51) Int. Cl. G06F 17/30

(52) U.S. Cl. 707/822; 707/E17.01

(57) ABSTRACT

Embodiments of the present invention may include a method and system for capturing, managing, and distributing computer files. The method and system may comprise a capture module configured to selectively capture images of computer files. The method and system may comprise a management module configured to organize the images of computer files in a unique configuration that is different than a configuration employed by a base system image. The method and system may also comprise a deployment module configured to deploy the images of computer files to a computer for recreation of the base system image.

### CROSS-REFERENCE TO RELATED APPLICATIONS

The present applications claims priority to U.S. Provisional Patent Application No. 61/176,763, filed May 8, 2009, entitled “Methods and Systems for Storing and Distributing Computer Software,” which is hereby incorporated in its entirety.

### BACKGROUND INFORMATION

Virtual machine technology provides many benefits for businesses. Businesses use virtual machines in many ways and in increasing number. However, because a virtual machine encapsulates an entire computer, use of virtual machines poses significant challenges due to its requirement for large amounts of data storage. Even a small virtual machine may easily be comprised of three or more gigabytes of data regardless of file format. When aggregated, a few hundred virtual machines may be comprised of several terabytes of data, which is not an unreasonable number considering how easily and quickly specialized virtual machines may be created.

The large storage requirements for virtual machines also make transporting virtual machines difficult. Even over fast networks, transferring a few virtual machines electronically over these networks may take a long time. Alternatively, when transported via physical media, a single virtual machine may be comprised of several DVDs or other large storage media, such as one or more external hard drives.

Although many attempts have been made to address these problems, conventional image techniques continue suffer a number of drawbacks.

### SUMMARY OF THE INVENTION

The following describes a method and a system in accordance with exemplary embodiments.

According to an exemplary embodiment, a method for capturing, managing, and distributing computer files may be provided. The method may comprise selectively capturing images of computer files, organizing the images of computer files in a unique configuration that is different than a configuration employed by a base system image, and deploying the images of computer files to a computer for recreation of the base system image. The method may also comprise storing the image of computer files in one or more storage units. The method may also comprise determining whether the computer files exist in one or more data storage units by analyzing one or more data storage units for the computer files.

According to an exemplary embodiment, a system for capturing, managing, and distributing computer files may be provided. The system may comprise a capture module configured to selectively capture images of computer files. The system may comprise a management module configured to organize the images of computer files in a unique configuration that is different than a configuration employed by a base system image. The system may also comprise a deployment module configured to deploy the images of computer files to a computer for recreation of the base system image.

According to an exemplary embodiment, a system for capturing, managing, and distributing computer files may be provided. The system may comprise a capture module configured to selectively capture images of computer files. The system may comprise one or more storage units configured to store the image of computer files. The system may also comprise a management module configured to organize the images of computer files in a unique configuration that is different than a configuration employed by a base system image and to determine whether the computer files exist in one or more data storage units by analyzing one or more data storage units for the computer files. The system may also comprise a deployment module configured to selectively deploy the images of computer files to a computer for recreation of the base system image.

It should be appreciated that the unique configuration may be based on a plurality of groupings comprising of application-based groupings, file-based groupings, customized groupings, or a combination thereof. In addition, the base system image may be recreated using the images of the computer files when the computer files are targeted for use at the computer, selected by a user at the computer, required to run an associated application at the computer, or a combination thereof.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 illustrates a system for storing and distributing computer files, in accordance with various exemplary embodiments;

FIG. 2 illustrates a system for storing and distributing computer files, in accordance with an exemplary embodiment;

FIG. 3 illustrates a virtual machine module for storing and distributing computer files, in accordance with exemplary embodiments;

FIG. 4 illustrates a modular system imaging format, in accordance with an exemplary embodiment;

FIG. 5 illustrates a file representation format for the modular system imaging format of FIG. 4, in accordance with an exemplary embodiment;

FIG. 6 illustrates a modular system imaging format, in accordance with another exemplary embodiment;

FIG. 7 illustrates a file representation format for the modular system imaging format of FIG. 6, in accordance with an exemplary embodiment;

FIG. 8 illustrates a modular system imaging format, in accordance with another exemplary embodiment;

FIG. 9 illustrates a file representation format for the modular system imaging format of FIG. 8, in accordance with an exemplary embodiment; and

FIG. 10 illustrates an illustrative flow of a method for storing and distributing computer files, in accordance with an exemplary embodiment.

These and other embodiments and advantages will become apparent from the following detailed description, taken in conjunction with the accompanying drawings, illustrating by way of example the principles of the various exemplary embodiments.

### DETAILED DESCRIPTION OF EXEMPLARY EMBODIMENTS

The description below describes servers, computers, and network elements that may include one or more modules, some of which are explicitly shown in the figures, others are not. As used herein, the term “module” may be understood to refer to software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. For modules that are software, a processor or other device may execute the software to perform the functions of the software. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, computers, network elements, etc.) separately. The functions described as being performed at various components may be performed at other components, and the various components may be combined and/or separated. Other modifications also may be provided.

As discussed above, virtual machine technology provides many benefits for businesses. However, because a virtual machine encapsulates an entire computer, use of virtual machines poses significant challenges due to its requirement for large amounts of data storage. The large storage requirements for virtual machines also make transporting virtual machines difficult. It should be noted that the challenge of maintaining computer system images only increases with company scale, particularly with organizations that maintain several computer system images and use a broad number of personal computer and server hardware models. Thus, a comprehensive and efficient system and method for capturing, storing, and distributing computer files may be provided.

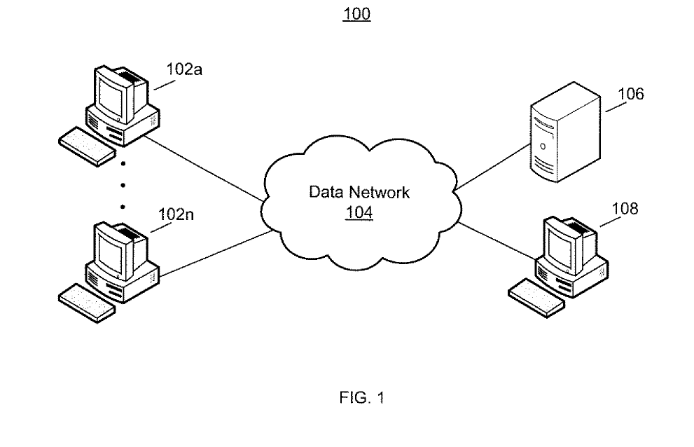

FIG. 1 illustrates a system for storing and distributing computer files 100, in accordance with various exemplary embodiments. The system 100 may provide for efficient capture, storage, distribution, management, and deployment of computer system images and hardware files to one or more target computers. The system 100 in accordance with exemplary embodiments may deploy a base system image to one or more target computers to quickly and efficiently replicate the base system image on a group of one or more target computers. In addition to deploying the base system image, the system 100 may identify and tailor distribution of hardware files from an archive based on hardware devices included in a given target computer, instead of deploying a single, one-size-fits-all computer system image that includes all hardware files that may be used by some, but not all, of the target computers in the group.

Conventional single, one-size-fits-all computer system images include many hardware files that may not be used by some or most of the target computers, and hence deploying such a one-size-fits-all system image may be wasteful of time, space, bandwidth, and/or other resources. Any organization implementing the system 100 in accordance with exemplary embodiments may achieve substantial savings in terms of time, bandwidth, and administrative complexity when managing and distributing computer system images to one or more target computers.

In an exemplary embodiment, the system 100 may include target computers 102a-102n, a data network 104, a server 106, and a base computer 108. The target computers 102a-102n, the server 106, and the base computer 108 may communicate with one another via the data network 104.

The components of system 100 may include a processor, a hard disk, a memory, a registry database, and one or more modules. The processor may be a central processing unit, a processing module, or other device capable of executing computer code. The hard disk may be a data storage device. The memory may store data loaded from the hard disk. The memory may be, for example, a Random Access Memory (RAM) or other device for storing data. The components of system 100 also may be communicatively coupled to one or more hardware devices, such as, but not limited to, a biometric device, a computer monitor, a video controller, a sound device, a mouse, a network interface card, a peripheral device, a touchscreen, a biometric reader (e.g., a fingerprint reader), or other hardware devices coupled to and communicating with the components of system 100.

The computer 102 may be a variety of electronic devices. These may include desktop computers, laptops/notebooks, servers or server-like systems, modules, Personal Digital Assistants (PDAs), smart phones, cellular phones, mobile phones, satellite phones, MP3 players, video players, personal media players, personal video recorders (PVR), watches, gaming consoles/devices, navigation devices, televisions, printers, and/or other devices capable of receiving and/or transmitting signals and/or displaying electronic content. It should be appreciated that the computers 102a-102n may be mobile, handheld, or stationary. It should also be appreciated that the computers 102a-102n may be used independently or may be used as an integrated component in another device and/or system.

The data network 104 may be a wired network, a wireless network, and/or combinations thereof. The data network 104 may transport digital and/or analog data signals using one or more transport protocols. The data network 104 may be any network, such as a local area network (LAN), a wide area network (WAN), a service provider network, the Internet, or other similar network. In some embodiments, the data network 104 may be a service provider network. It should be appreciated that the data network 104 may use electric, electromagnetic, and/or optical signals that carry digital data streams.

It should be appreciated that system 100 illustrates a simplified system, and that other devices and software not depicted may be included in the system 100. It should also be appreciated that the system 100 illustrates a single data network 104, a single server 106, and a single base computer 108. It should be appreciated that multiple instances of these devices may be also be provided.

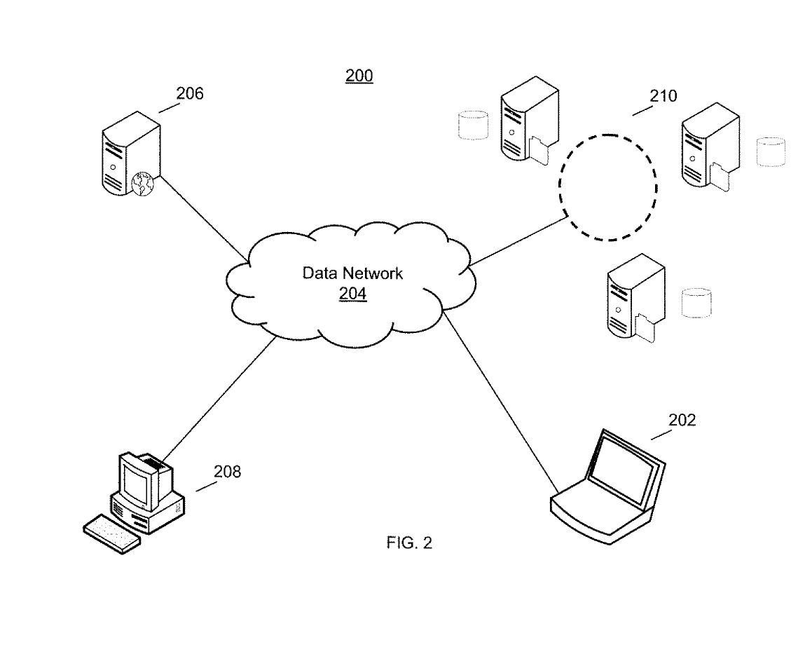

FIG. 2 illustrates a system for storing and distributing computer files 200, in accordance with an exemplary embodiment. The system 200 may provide for efficient capture, storage, distribution, management, and deployment of computer system images and hardware files to one or more target computers. The system 200 in accordance with exemplary embodiments may deploy a base system image to one or more target computers to quickly and efficiently replicate the base system image on a group of one or more target computers. In addition to deploying the base system image, the system 200 may identify and tailor distribution of hardware files from an archive based on hardware devices included in a given target computer, instead of deploying a single, one-size-fits-all computer system image that includes all hardware files that may be used by some, but not all, of the target computers in the group.

In an exemplary embodiment, the system 200 may include components similar to those shown in system 100 of FIG. 1. For example system 200 may include a target computer 202, a data network 204, a server 206, and a base computer 208. The server 206 may be a server that provides web services. The server 206 may provide logic and/or processing capability to configure and set up the data network 104 for communication and image capture and deploy. The base computer 208 may be a virtual machine builder. The system 200 may also include a one or more servers 210 that function as a resource library. The one or more servers 210 may be a collection of servers hosting a library resource for files, accessible through the data network 204. The components of system 200 may communicate with one another via the data network 104.

The computer 202 may be a virtual machine end user. In some embodiments, the end user may be provided a selectable catalog from which to install one or more virtual machines. In other embodiments, the end user may not be a fixed client. Rather, the end user may use a web-based application on the computer 202 to transfer payload. Other various embodiments may also be provided.

It should be appreciated that the components of the systems 100 and 200 may be servers, network storage devices or other devices communicatively coupled to the communication network 160. In one or more embodiments, components of the systems 100 and 200 may perform any, or a combination, of storing, receiving, transmitting, producing, aggregating, and/or uploading electronic content. The components of the systems 100 and 200 may also perform other functionality including, but not limited to, any, or a combination, of storing, indexing, consolidating, distribution, management, etc.

In some embodiments, the components of the systems 100 and 200 may contain or be communicatively coupled to storage, such as a redundant array of inexpensive disks (RAID), a storage area network (SAN), an internet small computer systems interface (iSCSI) SAN, a Fibre Channel SAN, a common Internet File System (CIFS), network attached storage (NAS), a network file system (NFS), tape drive based storage, or other computer accessible storage.

Additionally, components of the systems 100 and 200 may communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a common request broker architecture (CORBA) based interface, and other interfaces for sending or receiving information.

Data may be transmitted and received utilizing a standard telecommunications protocol or a standard networking protocol. For example, one embodiment may utilize Session Initiation Protocol (“SIP”). In other embodiments, the data may be transmitted or received utilizing other Voice Over IP (“VoIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, Internet Control Message Protocol (“ICMP”), User Datagram Protocol (“UDP”), or other protocols and systems suitable for transmitting and receiving data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols including IEEE 802.11a, 802.11b and 802.11g. Network 102 may also use protocols for a wired connection, such as an IEEE Ethernet 802.3.

Components of the systems 100 and 200 may each be responsible for different functionality in an electronic content distribution network. By way of non-limiting example, the components of the systems 100 and 200 may produce, receive, organize, aggregate, and deploy electronic content, such as system images. Processing of electronic content may include any, or a combination, of indexing, categorizing, storing, formatting, managing, translating, filtering, imaging, deploying, compressing, encrypting, securing, replicating, and further processing. System images and/or files may be produced by user or third-party input. By way of non-limiting example, content may be grouped or stored in databases or other storage, which may be separated according to various embodiments.

Referring to system 100, a system administrator or other user may desire to replicate common computer software applications, device drivers, files, data, etc., and/or other information to one or more of a group of target computers 102. The system administrator may install the desired computer software applications, device drivers, files, data, etc., and/or other information on the base computer 108. The system administrator may instruct the base computer 108 to create a base system image of the computer software applications, device drivers, files, data, etc., and/or other information to be commonly deployed to the target computers 102. The base system image may be a copy of the computer software applications, device drivers, files, data, etc., and/or other information installed on the base computer 108. The base system image may be a least common denominator of software and data that the system administrator desires to distribute to a group of target computers 102. For example, the system administrator may create a base system image containing an operating system and productivity and line-of-business applications to be used by each target computer 102 of the group of target computers 102a-102n.

In addition to creating the base system image, the system administrator may use the base computer 108 to create an image module. In an exemplary embodiment, the image module may be a standalone, portable archive that may provide logical and physical separation of software content (i.e., the base system image) from hardware platform support (i.e., hardware files). The portable archive, which may be compressed, may comprise one or more hardware files, and may also contain smart virtual machine executable code. For example, the image module may be a ZIP file (or other compressed file or file format) where the smart virtual machine executable code uses a commercially available application program interface (API) to extract the relevant hardware files to the target computers 102. Determining which hardware files to extract will be discussed in further detail below.

The separation of software content and hardware platform support may dramatically simplify the impact evaluation process when updating hardware or software of the target computers 102. For example, if a new hardware device (e.g., a new computer model, a new peripheral device, etc.) is introduced to one or more of the target computers 102, the IT staff may update the image module with hardware files to support the new hardware device without modifying the base system image. Separating hardware files from the base system image may decouple the base system image from hardware changes. Updates may be made to the image module, instead of to the base system image. This results in efficiencies as replicating the image module across the data network 104 is more efficient than adding new hardware files to the base system image because the hardware files may be much smaller than the base system image. Typically, a size of all of the hardware files included in the image module may be at least an order of magnitude smaller than the base system age. In another example, if the IT staff desires to add a new software application (e.g., productivity application) to one or more of the target computers 102, the IT staff may update the base system image to add the new software application without an update of the image module 250.

Alternatively, if a user who prepared a presentation on his or her computer or device, having its own set of specific hardware and software specifications, wanted to provide a demonstration of his or her presentation in another computer or device, having a different set of hardware and software specifications, the user may be able to do so seamlessly using the base image (which may be comprises of one or more sub-images) of his or her system. Separating hardware files from the base system image (or images) may decouple the base system image from hardware changes. Updates may be made to the image module, instead of to the base system image. This results in efficiencies as replicating the image module across the data network 104 is more efficient than adding new hardware files to the base system image because the hardware files may be much smaller than the base system image. Furthermore, the image module may be able to search and receive files necessary for seamless demonstration of the presentation or other application. This may be achieved with entirely or partially over the data network 104.

The following describes deploying a base system image to a target computer 102, where the target computer 102 locally accesses and executes the base system image and an image module communicatively coupled to the target computer 102. In an exemplary embodiment, the system administrator may locally deploy the base system age while working on a target computer 102 by reading the base system image from a recordable media (e.g., DVD, CD, Flash Drive, Universal Serial Bus (USB) Drive, etc.) and storing the base system image on a hard drive of the target computer. After the base system image has been deployed, the target computer 102 may access the image module by reading a recordable media and may execute the image module.

It is noted that the image module also may be accessed and executed at the server 106 via the data network 104 or at other locations local or remote to the target computer 102 and that the image module may interact with the target computer 102 via the data network 104. For example, the system administrator may deploy a base system image to one or more of the target computers 102a-102n from the server 106 via the data network 104 and the image module may interact with the target computer 102 via the data network 104. In another example, or the system administrator may deploy the base system image to the target computers 102 from the base computer 108 or other remote computers (not shown) via the data network 104 and the image module may interact with the target computer 102 via the data network 104. Other modifications also may be made.

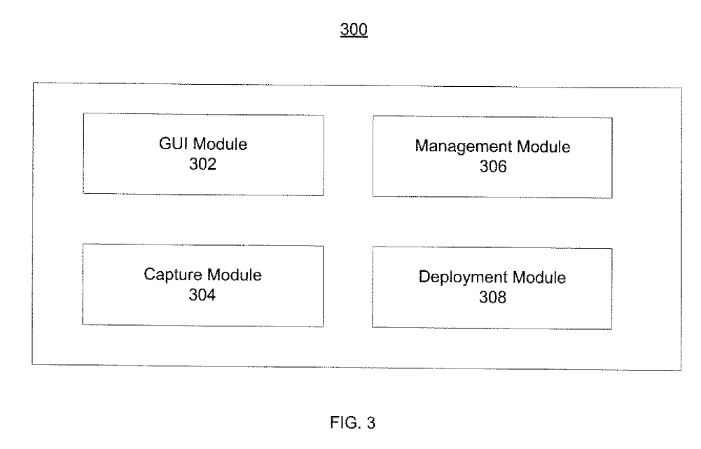

The components of system 100 may communicate with and/or execute the image module 300 of FIG. 3 to determine which hardware files to deploy to support the hardware devices.

FIG. 3 illustrates an image module for storing and distributing computer files 300, in accordance with exemplary embodiments. The image module 300 may include a graphical user interface (GUI) module 302, a capture module 304, a management module 306, and a deployment module 308. It is noted that modules 300, 302, 304, 306, and 308 are exemplary and the functions performed by one or more of the modules may be combined with that performed by other modules. The functions described herein as being performed by the modules 300, 302, 304, 306, and 308 also may be separated and may be performed by other modules remote or local to the computer 102 or 202.

The graphical user interface (GUI) module 302 may present various graphical user interfaces to the user at the computer 102 and/or 202. The graphical user interface provided by the GUI module 302 may allow a user to select one or more computer systems and/or collections of software for image creation. The computer systems may represent physical machines or virtual machines.

The capture module 304 may capture a virtual machine or software for a physical machine such as an operating system and/or a collection of software. The capture module 304 may be communicatively coupled with several other modules depicted in FIG. 3. For example, when capturing a virtual machine, the capture module 304 may operate alongside the other modules to ensure that the captured image is single-instanced and does not include duplicate files. Methods and systems for ensuring that a captured image is single-instanced are described in the U.S. patent application Ser. No. 12/023,534, filed Jan. 31, 2008, entitled “Method and System for Modularizing Windows Imaging Format,” which is hereby incorporated by reference in its entirety. Alternatively, the capture module 204 may also communicate with the other modules to determine whether the captured image may fit onto the media that will be used to distribute the image. For example, if the image is to be distributed via a network, the file size may be limited by the transmission capacity of the network. In other embodiments, if the parent image is greater in size than the storage capacity of a CD or DVD disk or other media, such as USB, flash, SD, or other similar storage media, then the image may be spanned over several disks/media.

The management module 306 may determine file size limitations based on the way (e.g., over a network, via physical media, etc.) with which the images are to be distributed. The management module 306 may be communicatively coupled with the other modules. The management module 306 may be used in a determination as to whether an image should be spanned across different media or distribution channels. In some embodiments, the management module 206 may also be communicatively coupled with a GUI module 302. In this scenario, the transmission/storage capacity of the network/media with which the image is to be distributed may be input by a user using the GUI module 302.

The creation of the image may take into account the capacity of the method of transmission with which the image is to be distributed. This information may be received from the management module 306 working in conjunction with the GUI module 302 and may determine which method with to distribute the images, e.g., via several transmissions over a network or over several physical media. The management module 306 may also be communicatively coupled with the capture module 304 and may refer to a system, a collection of software, or a combination of a collection of software and a system that is to be captured.

The management module 206 may create a consolidated image that is single-instanced and does not include duplicate files. The consolidation module may prevent the duplication of files and may therefore conserve memory space in both the physical and virtual machine context. Some of the functions of the management module 206 are described in the U.S. patent application Ser. No. 11/836,552, filed Aug. 8, 2007, entitled “Methods and Systems for Deploying Hardware Files to a Computer,” which is herein incorporated by reference in its entirety.

The deployment module 208 may distribute one or more images to the computer 102.

The methods and systems disclosed in the present application describe modularizing the image and storing the various components of the image on a central server. With this configuration, images (i.e., a software replica of a computer) may be created with reference to known images; thus decreasing the amount of data in each image. The process of creating software images from the computer's contents may be described as the “capture” process. Once captured, the software images may be deployed (i.e. run on a different machine) more efficiently and easily than using conventional media containing a large monolithic system image file. Using the systems and methods for capturing and organizing software images described herein, deployment may be accomplished with a much smaller file that may be emailed, downloaded, or linked to. Exemplary embodiments of the invention are described below.

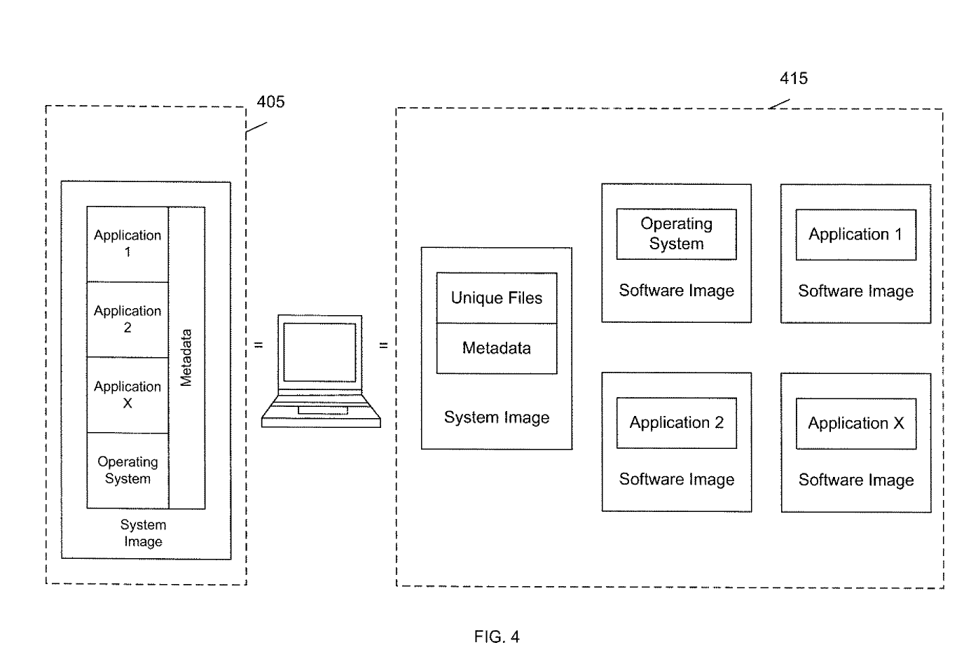

FIG. 4 illustrates a modular system imaging format, in accordance with an exemplary embodiment. In a conventional system, a computer system image 405 maybe captured in a one-size-fits-all fashion. However, the same computer system image 405, according to some embodiments, may be separated into one or more software images 415. Software images may contain only the files of a specific software program. For example, if a computer system image contains an operating system and three applications, it may be separated into four individual software images.

In an exemplary embodiment, the capture module 304 may identify what is unique to a given system when a remote computer is being captured. Further, the module may then replicates that process with reference to software images stored on a network server when recreating the system on the deploy side. The module may identify, isolate, and/or store files specific to a given software program, including but not limited to, operating systems, applications, software suites.

Embodiments of the present invention may be could be considered analogous to single-instance storage, except that it may be applied for software programs. In other words, single-instance storage in the creation of a system image may be a process that creates a system image without creating duplicate files. Here, that idea may still exist in that only the unique files are being stored as the image. These unique files, which are much smaller in size than the original image, may then be used to recreate the original image.

In an exemplary embodiment systems and methods perform the process of optimizing software images by identifying and removing system-unique files including but not limited to, registry hive files, system state files, log files. Exemplary systems and methods may perform the process of optimizing software images by identifying and removing system-unique metadata, including but not limited to, file security (access control lists), file attributes, file names, file path information.

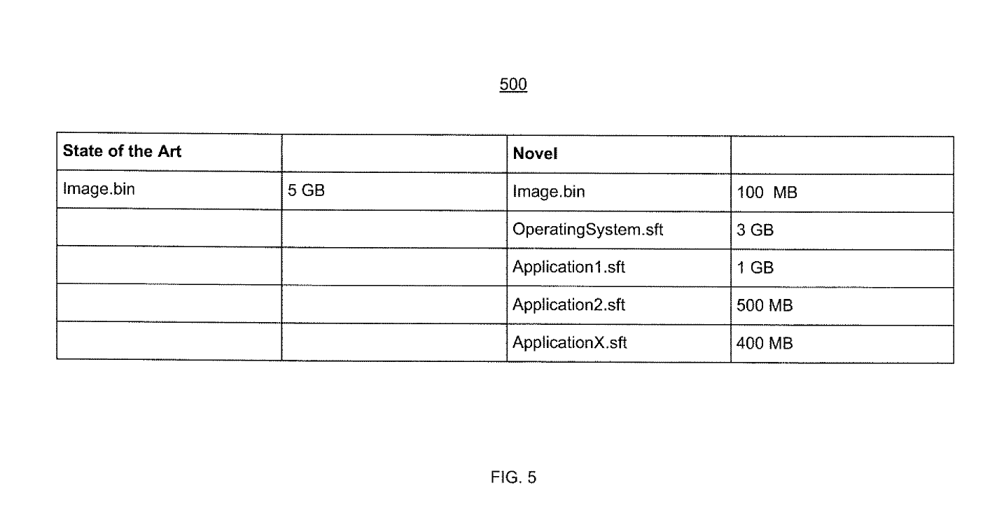

FIG. 5 illustrates a file representation format 500 for the modular system imaging format of FIG. 4, in accordance with an exemplary embodiment. A proprietary image format containing only a subset of the information contained within a software image may be provided. This format may be used in place of the larger software image format for purposes such as identifying what files to include or exclude from an image creation process. This image format may contain data including but not limited to; file hash table, file lookup table, etc.

In an exemplary embodiment, systems and methods implement the concept of using a proprietary image format that contains only a subset of the information found in traditional images. Specifically, an image format that is missing the actual file backing data, but contains file hash information to be used in identifying what files to include or exclude during image creation. This allows the creation of new system or software images without the presence of large software images. For example, a 5 GB software image may be represented by as little as 5 MB by selective capture (e.g., to backup one those resources that are needed or required). Other ways to reduce image size may also be provided, such as compression, etc.

The various embodiments described above provide advantageous solutions to various problems known to exist with conventional images. For example, in a business or other setting it might be necessary for a laptop to be imaged so that the exact contents of the laptop could be reproduced and deployed on another computer at another location. Conventional systems would create a system image that was an exact picture of the laptop, but the image might be large and not organized in a manner different from the organization of captured laptop. The large system image would then be physically sent on a disk, or possibly hosted on a website where it could then be downloaded, and restored using the same utility that captured the large image. This type of conventional capture-and-deploy scenario uses a tool that creates a system image and the same tool is then used to deploy the system image on a remote computer.

In embodiments of the present invention, the capture imaging process involves systems and methods where the computer's relevant files are selectively captured and organized in unique configurations as software images that are different from the configuration employed by the computer. Once captured, the software images may be stored in conventional formats or a repository of software images is maintained on a web server. The software images may then be deployed using proprietary systems and methods that recognize the selected and organized software images captured from the laptop and deploy the software images onto another remote computer such that the remote computer represents a copy of the original laptop. This allows the laptop to be imaged in ways described in various embodiments of these inventions in order to determine, for example, what aspects of the laptop are already stored in the library of programs, and what aspects are unique to that laptop. Using the systems and methods described herein one may generate a representation of the laptop using software images that is much smaller than a system image of the laptop captured in the conventional manner.

As previously stated, a problem associated with system imaging is the large size of the images. Various conventional solutions have been proposed that take steps to make an image smaller. Some conventional methods and/or systems have been successful in reducing the size of an image. In other words, rather than an image residing on several DVD disks, the conventional methods of making the image smaller have allowed for the image to reside on possibly even a single disk.

Creating a single large system image introduces a number of challenges. Because the system image must contain the software required for the majority of end users throughout a company, the system image may be very large and have adverse affects on storage and network infrastructure. It may also require significant ongoing maintenance due to the large list of software the system image contains. A single system age also represents a single point of failure, where a flaw could be replicated to all end users.

Creating several smaller system images based on end user geography, organization, or job role may alleviate some of the issues associated with fewer or single large system images, however they also introduce duplication of content both stored and distributed within a company network. Even conventional imaging methods that contain a single instance of common files within a system image file represent duplication and additional storage overhead when stored in more than one location.

Furthermore, not only is system image size reduced, an effective way for improved payload efficiency during transport may be provided. Using a combination of smaller system images and conventional software installation processes may represent an optimal balance of storage and network utilization.

The systems and methods described in various embodiments of this invention take a different approach than simply creating methods for reducing image size. The systems and methods described herein selectively create software images and organize (and reorganize) those software images in new advantageous ways. For example, virtual machines may be used by companies that want to distribute their virtual machines to many different employees located throughout the world.

To deploy a virtual machine to different employees located throughout the world, a company could utilize the systems and methods described herein to generate and then distribute smaller, web-based installation packages containing a deployment engine and system image that reference the software image library. For example, if a virtual machine contained Windows and Office, that virtual machine could be run through a special process which compared the virtual machine to the software image library—which may be accessible worldwide via the internet. This process may generate a small system image that would only have the unique files that were part of a particular demo that the virtual machine was created to run. This small file could be linked back to the customer who could provide the link to all of their employees that need to install this demo on their machine.

The employees may then click on the link and it will download that small version of the file. In embodiments of the present invention, the file includes instructions on how to put the virtual machine back together by referring to the software image that has already been replicated and is stored on an accessible network.

It should be appreciated that the unique configuration provided may not be limited to software applications, as depicted in FIG. 4. Other various embodiments for unique configurations may also be provided.

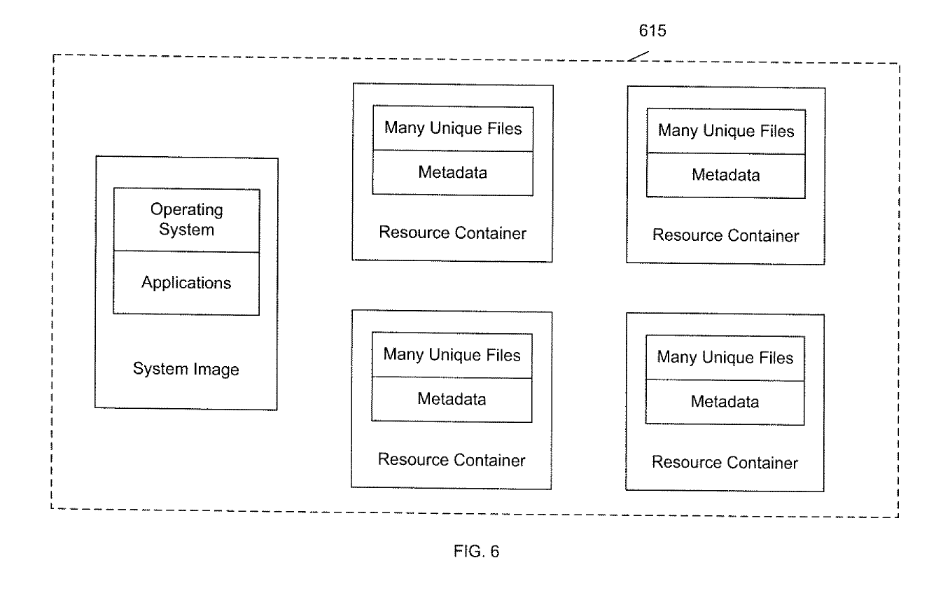

FIG. 6 illustrates a modular system imaging format 600, in accordance with another exemplary embodiment. Rather than capturing at the software or application level, the system image may be provided in a more granular configuration. As shown in the system imaging format 600, the system image may be organized in groups of unique files and metadata within “resource containers.” These resource containers may be comprised of more than one computer file, but less than a full software application, or a combination of large resource containers or elemental file images. A variety of configurations may be also be provided.

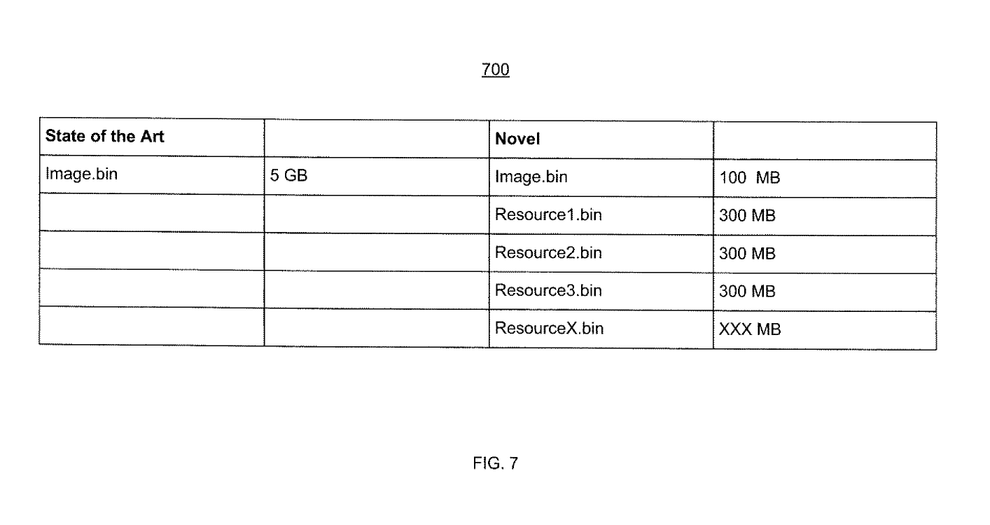

FIG. 7 illustrates a file representation format 700 for the modular system imaging format of FIG. 6, in accordance with an exemplary embodiment. A proprietary image format containing only a subset of the information contained within a software image may be provided. This format may be used in place of the larger software image format for purposes such as identifying what files to include or exclude from an image creation process. This image format may contain data including but not limited to; file hash table, file lookup table, etc.

In an exemplary embodiment, systems and methods implement the concept of using a proprietary image format that contains only a subset of the information found in traditional images. Specifically, an image format that is missing the actual file backing data, but contains file hash information to be used in identifying what files to include or exclude during image creation. This allows the creation of new system or software images without the presence of large software images. For example, a 5 GB software image may be represented by a variety of “resource containers,” which may represent a group of files or a single file. The group of files may be a software suite, a software application, and/or a cluster of files that work together within a software application. These resource containers may be of various sizes and offers flexibility in providing unique configuration of images for capture, storage, organization, and/or deployment.

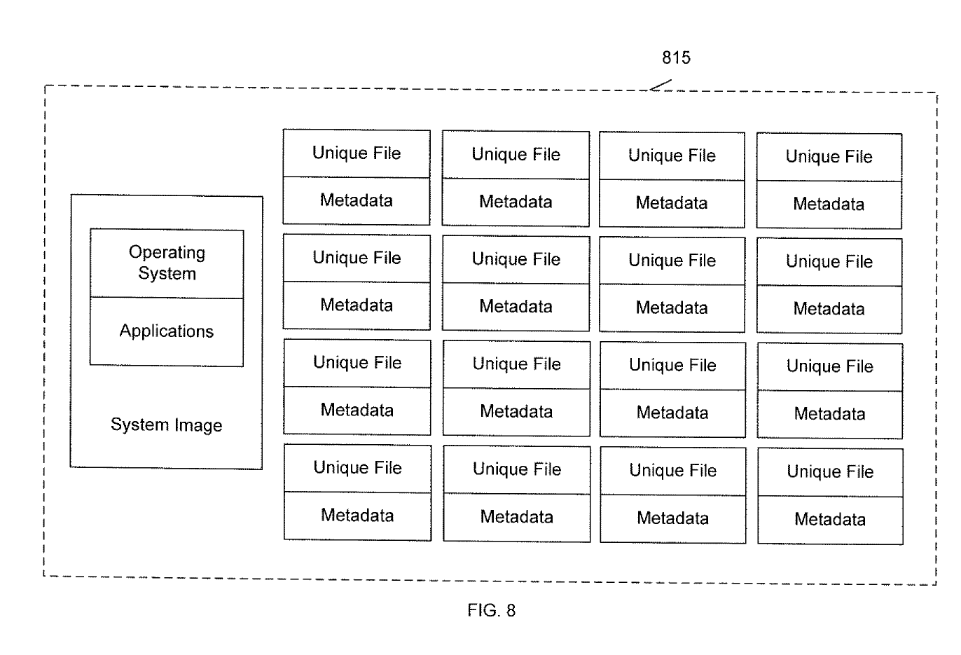

FIG. 8 illustrates a modular system imaging format 800, in accordance with another exemplary embodiment. In this example, unlike the format of 400 and 600, the system image format 800 may provide an even more granular configuration. As shown in the system imaging format 800, the system image may be completely broken down into individual files and corresponding metadata.

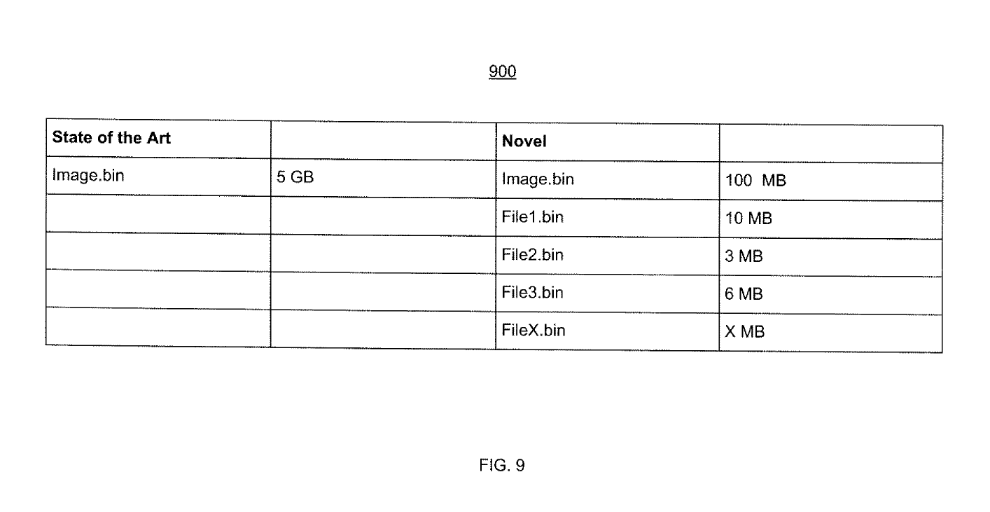

FIG. 9 illustrates a file representation format 900 for the modular system imaging format of FIG. 8, in accordance with an exemplary embodiment. A proprietary image format containing only a subset of the information contained within a software image may be provided. This format may be used in place of the larger software image format for purposes such as identifying what files to include or exclude from an image creation process. This image format may contain data including but not limited to; file hash table, file lookup table, etc.

In an exemplary embodiment, systems and methods implement the concept of using a proprietary image format that contains only a subset of the information found in traditional images. Specifically, an image format that is missing the actual file backing data may be recreated using software images of individual files. Capture, storage, organization, and deployment of these fundamental file images may be relatively simple and without the presence of large software images, which may be cumbersome if only a few file images are needed. As discussed above, individual file images may be used in conjunction with any of the embodiments described above to provide a robust yet efficient way to backup resources for deployment.

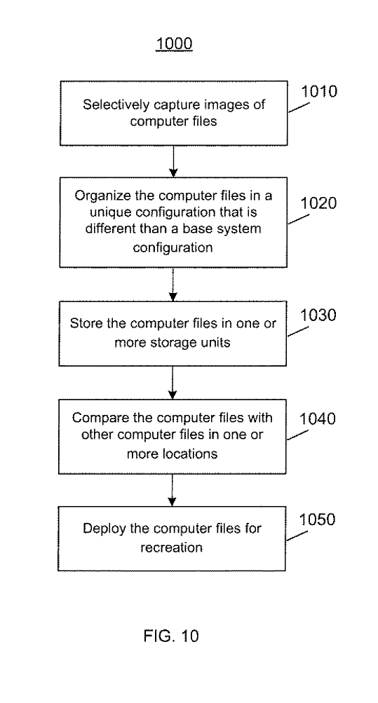

FIG. 10 illustrates an illustrative flow of a method for storing and distributing computer files, in accordance with an exemplary embodiment. The exemplary method 1000 is provided by way of example, as there are a variety of ways to carry out methods disclosed herein. The method 1000 shown in FIG. 10 may be executed or otherwise performed by one or a combination of various systems. The method 1000 is described below as carried out by at least system 100 in FIG. 1, system 200 in FIG. 2, and/or module 300 in FIG. 3, by way of example, and various elements of systems 100 and 200 and/or module 300 are referenced in explaining the example method of FIG. 10. Each block shown in FIG. 10 represents one or more processes, methods, or subroutines carried in the exemplary method 1000. Computer readable media comprising code to perform the acts of the method 1000 may also be provided. Referring to FIG. 8, the exemplary method 1000 may begin at block 1010.

At block 1010, the capture module 304 is configured to selectively capture images of computer files. In some embodiments, the capture module 304 may selectively capture images of computer files by building out a virtual machine containing the computer files to be captured. The computer files for capture may be mounted to at least one storage medium. The computer files may be copied and converted into an imaging file format. In some embodiments, conversion may be achieved using conversion tools, such as SmartWIM, Microsoft ImageX, or other imaging/conversion tools.

At block 1020, the management module 306 is configured to organize the images of computer files in a unique configuration that is different than a configuration employed by a base system image. In some embodiments, the images of computer files may be organized by at least one of type, size, name, application, extension, designation, metadata, and program association.

It should be appreciated that in some embodiments, the unique configuration may be application-based, such that the images of computer files are organized in groups based on an application, a program, an operating system, or an application suite. In other embodiments, the unique configuration may be file-based, such that the images of computer files are organized as individual file images. In yet other embodiments, the unique configuration may be based on a plurality of groupings comprising application-based groupings, file-based groupings, customized groupings, or a combination thereof. Using a unique configuration, as described above, as opposed to a single base system image may provide efficient capture, storage, and deployment and optimizes performance.

At block 1030, the management module 306 may be configured to store the image of computer files in one or more storage units communicatively coupled to the module (e.g., image module 300).

At block 1040, the management module 306 may also be configured to determine whether the computer files exist at one or more data storage units. In some embodiments, the determination may be achieved by analyzing the one or more data storage units for the computer files.

At block 1050, the deployment module 308 may be configured to deploy the images of computer files to a computer for recreation of the base system image. In some embodiments, the images of the computer files may be selectively deployed. In effect, the base system image may recreated using the images of the computer files when the computer files are targeted for use at the computer, selected by a user at the computer, required to run an associated application at the computer, or a combination thereof.

In other words, deployment may include a gradual building of the new virtual machine in sort of a “piece meal” fashion as opposed to deploying everything at once, e.g., in one single base system image. In this example, the storage for resources may, in effect, become “smarter” since it may gets built as a user decides what he or she wants to access and what he or she will need. Therefore, assuming the images may exist and are stored in the cloud (e.g., data network 104) or other location, the user deciding that he or she needs to do X, Y, or Z, the images of computer files that are required to perform X, Y, or Z may then be pulled and/or deployed to the user's device.

The advantage of such “smart” and “selective” deployment may be an increase level of efficiency in distributing virtual machines. It should be appreciated that there may be a one to one ratio between a source virtual machine and the deployed virtual machine. In other words, the deployed virtual machine may be exactly the same as the source virtual machine. There may be flexibility, however, in the middle of the process, which determines how the virtual machine is efficiently deployed from one to the other. Thus, the virtual machine does not necessarily grow or change and once deployed, the virtual machine is entirely at the end user's disposal and he or she may do with it whatever they want. From a deployment side of things, back and forth communication may be reduced, if not fully terminated, once the virtual machine has been fully deployed. Accordingly, a key feature may be that the resources (e.g., as they exist in the cloud) may be leveraged in an ongoing basis to provide a “smart cache” so that end users only download resources that they need for the content that they care about. Therefore, what end users receive is not one large image blob that contains resources for, say, fifteen (15) different virtual machines when they really only care about one. They download only the resources or relative resources that they need for all the content that they need. Over time, the system may become “smarter” because as the end user continues to use the content that he or she may be interested in and download only the resources for the content he or she needs (and thus not having to pull down all resources for content he or she us not currently interested in).

In another example, it should be appreciated that if a user desires to pull down Virtual Machine A and that Virtual Machine A may contain an operating system and an application suite (e.g., Microsoft Office). After a week, the user may now decide that he or she needs Virtual Machine B. Virtual Machine B may include the operating system, the application suite, plus an additional application associated with the application suite (e.g., Visual Studio). In this scenario, the “smart cache” may know that the end user may have all the images/files for the operating system and the application suite (from Virtual Machine A). Accordingly, the operating system and application suite may not be pulled since it may already be in local storage. Therefore, the only item required for transfer in order to form Virtual Machine B may be transferring the files associated with the additional application. As a result, as more and more data gets downloaded, not only does the cache increase in size, but it may also gets “smarter,” recreating the virtual machine an efficient manner that optimized resources.

Thus, the system in accordance with exemplary embodiments may detect what hardware files are used by particular target computers and may deploy the hardware files used by particular target computers. This advantageously does not burden the base system image with hardware files that are used by only a subset of the target computers. Moreover, the system in accordance with exemplary embodiments advantageously uses the image module to separate the base system image from the hardware files. Updates to the hardware files may be made and an update image module may be distributed without involving redistributing the base system image to all target computers. Likewise, the base system image may be updated with involving redistribution of the image module. This separation results in savings in terms of time, bandwidth, and administrative complexity for any organization that approaches deployment of base system images as described herein.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method comprising:
selectively capturing images of computer files;
organizing the images of computer files in a unique configuration that is different than a configuration employed by a base system image; and
deploying the images of computer files to a computer for recreation of the base system image.

2. The method of claim 1, further comprising storing the image of computer files in one or more storage units.

3. The method of claim 1, further comprising determining whether the computer files exist in one or more data storage units by analyzing one or more data storage units for the computer files.

4. The method of claim 1, wherein selectively capturing comprises building out a virtual machine containing the computer files to be captured.

5. The method of claim 1, wherein selectively capturing comprises mounting the computer files to at least one storage medium for capture.

6. The method of claim 1, wherein selectively capturing comprises copying and converting the computer files into an imaging file format.

7. The method of claim 1, wherein the images of computer files are organized by at least one of type, size, name, application, extension, designation, metadata, and program association.

8. The method of claim 1, wherein the unique configuration is application-based, such that the images of computer files are organized in groups based on an application, a program, an operating system, or an application suite.

9. The method of claim 1, wherein the unique configuration is file-based, such that the images of computer files are organized as individual file images.

10. The method of claim 1, wherein the unique configuration is based on a plurality of groupings comprising application-based groupings, file-based groupings, customized groupings, or a combination thereof.

11. The method of claim 1, wherein the unique configuration provides efficient capture, storage, and deployment and optimizes performance when compared to capture, storage, and deployment of a single base system image.

12. The method of claim 1, wherein the images of the computer files are selectively deployed.

13. The method of claim 12, wherein the base system image is recreated using the images of the computer files when the computer files are targeted for use at the computer, selected by a user at the computer, required to run an associated application at the computer, or a combination thereof.

14. The method of claim 12, wherein the images of computer files not locally stored are selected for deployment on an as-needed basis to recreate the base system image over a period of time.

15. A computer readable medium comprising code to perform the acts of method 1.

16. A system comprising:
a capture module configured to selectively capture images of computer files;
a management module configured to organize the images of computer files in a unique configuration that is different than a configuration employed by a base system image; and
a deployment module configured to deploy the images of computer files to a computer for recreation of the base system image.

17. A system comprising:
a capture module configured to selectively capture images of computer files;
one or more storage units configured to store the image of computer files;
a management module configured to organize the images of computer files in a unique configuration that is different than a configuration employed by a base system image and to determine whether the computer files exist in one or more data storage units by analyzing one or more data storage units for the computer files, wherein the unique configuration is based on a plurality of groupings comprising of application-based groupings, file-based groupings, customized groupings, or a combination thereof; and
a deployment module configured to selectively deploy the images of computer files to a computer for recreation of the base system image, wherein the base system image is recreated using the images of the computer files when the computer files are targeted for use at the computer, selected by a user at the computer, required to run an associated application at the computer, or a combination thereof.
